(19) United States
(12) Patent Application Publication
(10) Pub. No.: US 2009/0297371 A1
(43) Pub. Date: Dec. 3, 2009

(54) FLUID DELIVERY DEVICES

(75) Inventors: Min-Hon REI, Tao Yuan (TW); Yu-Lin Chen, Tao Yuan (TW); Guan-Tyng Yeh, Tao Yuan (TW)

Correspondence Address: VENABLE LLP, P.O. BOX 34385, WASHINGTON, DC, 20043-9998, US

(73) Assignee: Green Hydrotec Inc., Tao Yuan (TW)

(21) Appl. No.: 12/397,664

(22) Filed: Mar. 4, 2009

(30) Foreign Application Priority Data
May 29, 2008 (TW) 097119884

(51) Int. Cl. F04B 17/00; F02G 1/04

(52) U.S. Cl. 417/379; 60/516

(57) ABSTRACT

A fluid delivery device is provided. The device comprises an internal container, an external container and a first delivery pipe. The internal container has a first space for containing a fluid to be delivered. The external container substantially surrounds the internal container to form a substantially sealed second space between the internal container and the external container, wherein the second space is for an assistant liquid. The assistant liquid is heated to raise the pressure in the second space, and then, the internal container is pressed, thereby driving the fluid out along the first delivery pipe.

This application claims benefit from the priority of Taiwan Patent Application No. 097119884 filed on May 29, 2008, the disclosure of which is incorporated by reference herein in their entirety.

### CROSS-REFERENCES TO RELATED APPLICATIONS

Not applicable.

### BACKGROUND OF THE INVENTION

1. Field of the Invention

The present invention provides a fluid delivery device. In particular, the present invention provides a portable and non-directional fluid delivery device suitable for delivering a small amount of fluid, which can be applied in portable miniature products. For example, it can be used in a fuel cell system to provide material(s) required for cell operation.

2. Descriptions of the Related Art

Traditionally, mechanical pumps are used for fluid delivery. A pressure source is generated by mechanical compression, so that a fluid is transported from one high-pressure end to another low-pressure end. Although this kind of mechanical pump usually has greater delivery ability, it has a larger system volume and consumes more energy.

However, current products, such as 3C products and fuel cells, are all becoming miniaturized, and the delivery for only a small amount of fluid is often involved. Thus, traditional mechanical pumps with greater delivery ability are not appropriate. In addition, their large volumes are not suitable for high-tech products, in which miniaturization is in high demand. Furthermore, with the progress of technology and the need for environmental protection, every invention/design has tried to lower the amount of energy consumed. The traditional mechanical pumps in operation require the use of constant electric power for delivery, and thus, clearly can't meet the expectation. Hence, it is important to provide a miniaturized fluid delivery device that not only delivers a small amount of fluid, but also consumes a lower amount of energy.

In the prior art, the principle of capillary siphoning has been applied to the delivery technique for small amounts of fluid, in which the gravity of a fluid to be delivered is overcome by the capillary siphoning. Nevertheless, capillary siphoning is influenced by not only the kind of fluids to be delivered and surface tension, but also temperature, pressure, and other factors. For instance, when the pressure at the delivered end is higher, it is difficult to solely use capillary siphoning to deliver the fluids. Moreover, once an employed capillary is installed, the flow amount delivered within a unit time cannot be adjusted, and thus, making it inconvenient in application.

The present invention provides a portable fluid delivery device for delivering a small amount of fluid with a small operation volume, ability to deliver liquid stably, flexibility for changing the flow amount depending on the requirements, and low-energy consumption, etc.

### SUMMARY OF THE INVENTION

One objective of this invention is to provide a fluid delivery device, comprising an internal container with a first opening and a first space for containing a fluid to be delivered, wherein the internal container is made of a flexible material; an external container substantially surrounding the internal container to form a substantially sealed second space between the internal container and the external container, wherein the external container has a second opening corresponding to the first opening and is made of a rigid material; an assistant liquid in the second space, wherein the boiling point of the assistant liquid is not higher than that of the fluid to be delivered; and a first delivery pipe, including a first segment within the first space and a second segment stretched out from the first opening, wherein the first segment has a hole for communicating with the first space and the second segment is tightly bound with the first opening and the second opening and has a fluid outlet. When the device is in a state of use, the first space contains a fluid to be delivered, the assistant liquid is heated and vaporized by a heat resource to raise the pressure in the second space to cause a pressure difference between the first space and the second space; and the internal container is compressed by the pressure difference to drive the fluid in the first space out from the delivery device via the first delivery pipe and the fluid outlet.

Another objective of this invention is to provide a fluid delivery device, comprising: an internal container with a first opening and a first space for a fluid to be delivered, wherein the internal container is made of a flexible material; an external container substantially surrounding the internal container to form a substantially sealed second space between the internal container and the external container, wherein the external container has a second opening and an inlet for filling an assistant liquid and is made of a rigid material, and the second opening corresponds to the first opening; a second switching structure for controlling the inlet for filling an assistant liquid, installed to correspond to the inlet for filling an assistant liquid; and a first delivery pipe, including a first segment within the first space and a second segment stretched out from the first opening, wherein the first segment has a hole for communicating with the first space and the second segment is tightly bound with the first opening and the second opening. Besides, the second segment has a fluid outlet, wherein, when the fluid delivery device is in a state of use, the first space contains a fluid to be delivered and the second space contains an assistant liquid, wherein the boiling point of the assistant liquid is not higher than that of the fluid to be delivered. The assistant liquid is heated and vaporized by a heat resource to raise the pressure in the second space to cause a pressure difference between the first space and the second space. The internal container is compressed by the pressure difference to drive the fluid out from the delivery device via the first delivery pipe and the fluid outlet.

The subject invention is described in detail with preferred embodiments in the following paragraphs accompanying the appended drawings for people skilled in this field to well appreciate the aforesaid purposes, the technical features, and the advantages of the claimed invention.

### BRIEF DESCRIPTION OF THE DRAWINGS

FIG. 1 is an embodiment of the fluid delivery device according to the present invention;

FIG. 2A is a schematic diagram illustrating an embodiment of binding the internal container and the outer container in the fluid delivery device according to the present invention;

FIG. 2B is a schematic diagram illustrating another embodiment of binding the internal container and the outer container in the fluid delivery device according to the present invention;

FIG. 2C is a schematic diagram illustrating yet another embodiment of binding the internal container and the outer container in the fluid delivery device according to the present invention;

FIG. 3A shows an embodiment of the fluid delivery device according to the present invention in which a direct heating method is adopted;

FIG. 3B shows an embodiment of the fluid delivery device according to the present invention in which an indirect heating method is adopted;

FIG. 4 shows an embodiment of the fluid delivery device according to the present invention comprising two internal containers;

FIG. 5 shows another embodiment of the fluid delivery device according to the present invention;

FIG. 6 shows yet another embodiment of the fluid delivery device according to the present invention;

FIG. 7 shows an embodiment of the fluid delivery device according to the present invention comprising a second switching structure; and

FIG. 8 shows the relationship of the pressure difference versus the flow rate at the outlet as illustrated in Example 3.

### DESCRIPTION OF THE PREFERRED EMBODIMENT

The vocabulary used herein is for describing embodiments only, not for limiting the scope of the present invention. For example, unless specifically defined, the word “a(n)” covers singular and plural forms. For instance, “an internal container” may represent one internal container or two or more internal containers, and “a hole” may represent one hole or two or more holes.

The embodiments of the present invention will be specifically described with the appended drawings as following. However, this invention can be carried out in many different forms, and thus, the scope of the present invention should not be limited to the embodiments described in this specification. In addition, for clarity, the size of each element and each area may be exaggerated in the figures and is not depicted as their actual scale.

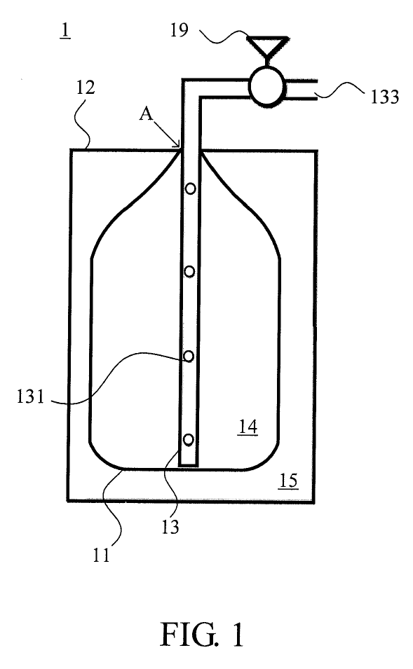

Firstly, in reference to FIG. 1, a fluid delivery device 1 according to the present invention comprising an internal container 11, an external container 12, and a first delivery pipe 13 is shown. The internal container 11 has a first opening (not indicated) for stretching the first delivery pipe 13 out of the internal container 11, and the interior of the internal container 11 forms a first space 14 for containing the fluids to be delivered. The external container 12 substantially surrounds the internal container 11 to form a substantially sealed second space 15 between the internal container 11 and the external container 12. The fluid delivery device 1 further comprises an assistant liquid contained in the second space 15.

As shown in FIG. 1, the external container 12 has a second opening (not indicated) corresponding to the first opening for stretching the first delivery pipe 13 therefrom. In this specification, “a second opening corresponding to the first opening” or “having a second opening corresponding to the first opening” means that when there is a first opening, a second opening is installed correspondingly, or vice-versa. Although the embodiment shown in FIG. 1 indicates that the positions of the first opening and the second opening are overlapping correspondingly (i.e. the position indicated by the arrow A), the situation that the positions are not overlapping is not excluded. For example, on the external wall of the first delivery pipe 13, the second opening is arranged above the first opening.

When the fluid delivery device 1 is in a state of use, the fluid to be delivered is placed in the first space 14. The assistant liquid in the second space 15 is heated and vaporized to raise the pressure in the second space 15 to cause a pressure difference between the interior and the exterior of the internal container 11, so that the internal container 11 is compressed to drive the fluid out via the first delivery pipe 13.

The internal container 11 should be made of a flexible material, so that the distortion of the internal container 11 can be generated when it is subjected to an external pressure. In addition, to prevent the internal container 11 from damaging by the properties of the fluid to be delivered or the assistant liquid itself (e.g. corrosiveness), or by the delivery process driven by heating/compression (i.e. to consider the factors such as the kinds of fluids to be delivered and assistant liquids, the operation temperature of the device, and the like), the material of the internal container 11 preferably has good pressure resistance, heat resistance, corrosion resistance, and the like, depending on the requirements. Materials suitable for the material of the internal container 11 can be such as, but not limited to, polyethylene, polyvinyl chloride (PVC), neoprene, silicone rubber, and the like. The preferred materials are neoprene and silicone rubber. Additional processing can be carried out on the surface of the internal container 11 that comes into contact with the fluid to be delivered or the assistant liquid to provide the desired fluid resistance.

The fluid delivery device 1 can be used for delivering any fluid that is in the liquid state at room temperature. Non -limiting examples for the fluids are alcohols, alkanes, water, and a combination thereof. Preferably, the fluids are selected from a group consisting of water, methanol, ethanol, gasoline, diesel fuel, and combinations thereof. In an embodiment of the present invention, the fluid delivery device 1 is used for delivering methanol or a methanol aqueous solution for the operation of a fuel cell.

The selection of assistant liquids depends on the kind of fluids to be delivered, and the premise is that the boiling point of the assistant liquid should not be higher than that of the fluid to be delivered. Thus, the assistant liquid can be evaporated during the heating process to generate a pressure driving the fluid to flow out from the internal container 11. For instance, if the fluid to be delivered is water, methanol, ethanol, or a combination thereof, the assistant liquid can be selected from a group consisting of water, a C₅-C₆ hydrocarbon (which can be branched chain, straight chain, cyclic shape, saturation, or unsaturation), a C₂-C₃ carbonyl compound, a C₁-C₂ alcohol, and combinations thereof. For example, the assistant liquid can be selected from a group consisting of pentane, cyclopentane, hexane, cyclohexane, acetone, propanal, and combinations thereof. If the fluid is gasoline or diesel fuel, the assistant liquid can be selected from a group consisting of: gasoline, diesel fuel, methanol, isopropanol, dichloromethane, and combinations thereof.

To generate a pressure compressing the internal container 11 when the assistant liquid is heated and evaporated, the external container 12 is made of a substantially rigid material. Any suitable rigid material can be used to provide the external container 12, and a material with pressure resistance, heat resistance, assistant liquid resistance, and the like is preferred. In addition, depending on the requirements, the surface of the external container 12 coming into contact with the assistant liquid can be processed to provide the appropriate assistant liquid resistance. Non-limiting examples for a rigid material used to manufacture the external container 12 can be selected from plastic, metal, and a combination thereof, such as polypropylene, polyethylene, stainless steel, aluminum, or a combination thereof.

Further referring to FIG. 1, the first delivery pipe 13 of the fluid delivery device 1 can be further divided into a first segment and a second segment. The first segment is within the first space 14, and the rest is the second segment. The first segment has a hole 131 to make the interior of the first delivery pipe 13 communicate with the first space 14. According to the device of the present invention, the first segment can be installed with one or a plurality of holes 131. A plurality of holes 131 is preferred. In principle, there is no a particular limit on the installation position of the holes 131. For instance, in FIG. 1, the holes 131 are uniformly installed in the axial direction of the first delivery pipe 13. In an embodiment comprising a plurality of holes 131, the holes 131 are not all on the same line parallel to the axial line of the first delivery pipe 13. In an embodiment of the present invention, the first segment of the first delivery pipe 13 can be sealed to prevent the internal container 11 from abrasion or even break due to the friction caused by the end of the first delivery pipe 13 in the first segment when the internal container 11 is subjected to compression by the increased pressure from the second space 15.

The second segment of the first delivery pipe 13 refers to the portion of the first delivery pipe 13 stretched out from the first opening, while the second segment has a fluid outlet 133 and is tightly bound with the first opening and the second opening. Generally speaking, there is no a particular limit on the way of binding, as long as there is no liquid or gas leakage. For instance, a chemical approach, a physical approach, or a combination thereof can be used. In terms of chemical approaches, a suitable adhesive can be used on the fluid delivery device 1 to stick the first/second opening to a corresponding position on the outside of the first delivery pipe 13 to prevent gas and/or liquid from leaking out of the fluid delivery device 1. There is no a particular limit on the employed adhesive, usually, for example, unsaturated polyester resin, epoxy resin, furan-formaldehyde resin, phenol resin, or the like can be used. Also, when the first delivery pipe 13, and the internal container 11 and/or the external container 12 are made of a thermoplastic material, a thermo-pressing method can be applied to make the first/second opening tightly bind to the first delivery pipe 13.

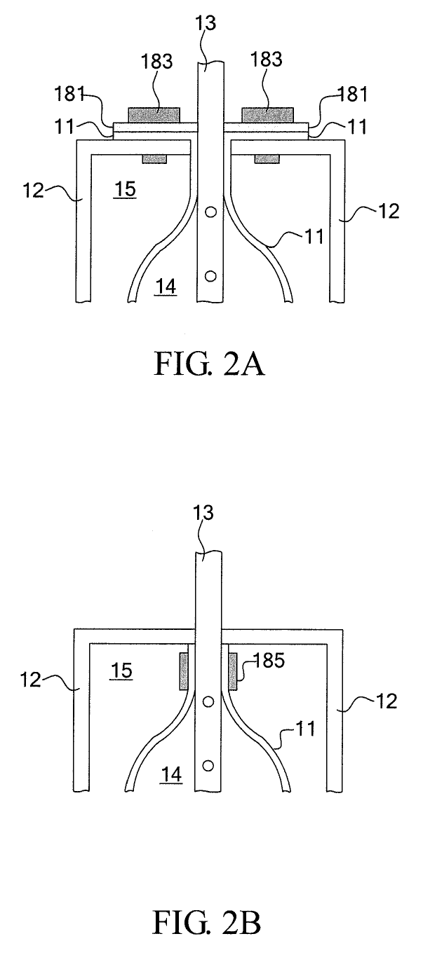

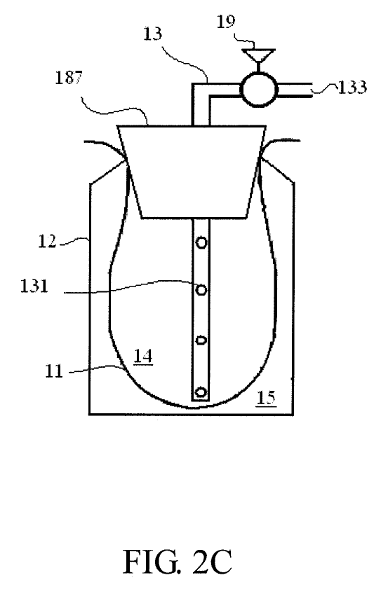

Physical approaches also can be used to make the first and the second openings tightly bind to the first delivery pipe 13. For example, referring to FIG. 2A, a zoom-in schematic diagram for part of the embodiment adopted in the fluid delivery device of the present invention is shown. A fixing plate 181 and an accompanied fixing bolt 183 are used to fix the internal container 11 partially pulled out on the external container 12. Also, as shown in FIG. 2B, a fixing ring 185 can be used to fix the internal container 11 at the first opening on the first delivery pipe 13, in combination with an adhesive to adhere the second opening to the first delivery pipe 13. Alternatively, referring to FIG. 2C, a silica gel plug 187 is used to bind the external container 12 and the internal container 11 by pressing down the silica gel plug 187 directly, wherein the first delivery pipe 13 directly passes through the silica gel plug 187. In addition, when the external container 12 and the first delivery pipe 13 are made of metals, the second opening and the first delivery pipe 13 can be bound by welding.

As described hereinbefore, the preferred embodiment of the fluid delivery device according to the present invention is installed with a plurality of holes 131 which are not all on the same line parallel to the axial line of the first delivery pipe 13. Because the first delivery pipe 13 has a plurality of holes 131 installed in the aforesaid way, the fluid that is delivered can enter the first delivery pipe 13 through the holes 131 from different directions when the internal container 11 is subjected to the compression, and thus does not limit the delivery direction and prevent blockage. Herein, the first delivery pipe 13 should be made of a rigid material to prevent it from distortion during the compression process and hindering the fluid delivery. Hence, the material of the first delivery pipe 13 should be selected from materials with the properties of pressure resistance, heat resistance, and corrosiveness resistance. For instance, it can be selected from a group consisting of stainless steel, aluminum, polyvinyl chloride (PVC), polyvinylidene chloride (PVDC), and combinations thereof.

In an embodiment of the present invention, the first space 14 is filled with a fluid to be delivered; that is, there is no gas in the first space 14. Thus, if there is any movement during operation, the fluid to be delivered still can be introduced into the first delivery pipe 13 through the holes 131 in any placing direction, to achieve the desired fluid delivery.

To further increase the convenience of utilization and the environmental protection, the fluid delivery device according to the present invention is preferably designed to be used repeatedly. Namely, the present invention is designed to be optionally filled with one or more fluids to be delivered in the internal container 11. The fluid to be delivered can be filled through the outlet of the first delivery pipe, or be filled through an additional inlet (which will be described in the subsequent embodiment). When a fluid to be filled is different from the originally filled fluid, a cleaning process can optionally be carried out before the different fluid is filled. For example, a cleaning solution is introduced into the internal container 11 and then is discharged by the fluid delivery method described hereinbefore. Finally, air is injected and purged into the internal container to dry it. People with ordinary skill in the art may proceed with a suitable cleaning process and choose an appropriate cleaning solution based on their knowledge, and the details are not described herein.

When the fluid delivery device according to the present invention is in a state of use, an assistant liquid is evaporated to generate a vapor pressure by heating the assistant liquid in the second space 15 to increase the pressure in the second space 15. The internal container 11 is subjected to compression due to the pressure difference between the first space 14 and the second space 15 to drive the fluid to be delivered in the first space 14 to enter the first delivery pipe 13 from the holes 131 and finally be discharged from a fluid outlet 133. The generated vapor pressure in the second space 15 can be controlled by adjusting the intensity of a heat source to further modulate the flow amount of the fluid delivery. Any suitable heating method can be adopted depending on the requirements. For example, the heat source that can be applied to the device according to the present invention can be selected from a group consisting of a high-temperature liquid, a high-temperature gas, chemical reaction heat, an electric heating wire, a heating band, a hot air pipe, a hot liquid pipe, an electric fire, and combinations thereof.

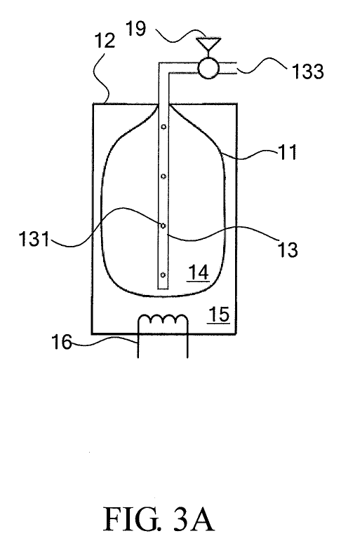

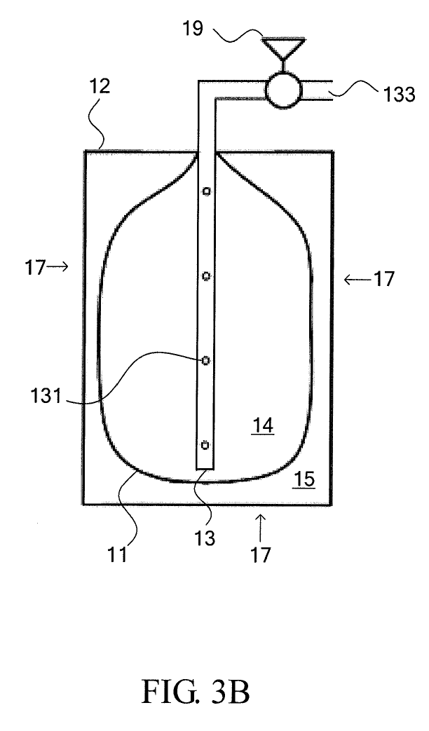

For instance, the fluid delivery device according to the present invention can be used by adopting the approach of heating an assistant liquid directly or indirectly. As shown in FIG. 3A, a heat source 16 can be installed in the second space 15 to heat the assistant liquid directly, and a heat source device, such as an electric heating wire, a heating band, a hot air pipe, a hot liquid pipe, or the like, can be adopted. Also, as shown in FIG. 3B, the external container 12 is heated by a heat source 17 to heat the assistant liquid indirectly. Herein, the waste heat or residual heat of an adjacent heating element can be absorbed to be provided as a heat source. In addition, a suitable heating device that can generate high temperature to produce a heat source can be used, as well as placing the fluid delivery device in a higher temperature environment. Therefore, other heat sources in the environment, such as the waste heat discharged by every kind of electrical appliances, vehicles, and the like in operation, or the waste heat, high-temperature waste water, and the like generated by devices in operation, can be used sufficiently to meet the effect of the environmental protection and energy conservation. People with ordinary skill in the art and with common knowledge may proceed with a variety of modifications by conventional methods depending on the requirements, and the details are not described herein.

To maintain the utilization efficiency of the fluid delivery device according to the present invention, the fluid delivery device preferably comprises a controlling element with a switch function to segregate the first delivery pipe 13 from outside as the fluid delivery device is not in a state of use, thereby to prevent outside air from entering the first space 14. As shown in FIG. 1, on the basis of the demand for application, a controlling element 19 can be installed on the second segment of the first delivery pipe 13. The controlling element 19 may simply provide a switch function, or may further have a function of controlling and modulating the flow amount. For instance, a normal metering device (e.g. a metering valve, such as a needle valve) can be used directly as the controlling element 19 and meanwhile to control the switch and output flow amount of the fluid delivery. Also, the end of the second segment can be formed into a capillary shape, and the flow amount is controlled by changing the length of the capillary, and in this case, the employed controlling element 19 only needs to have a switch function.

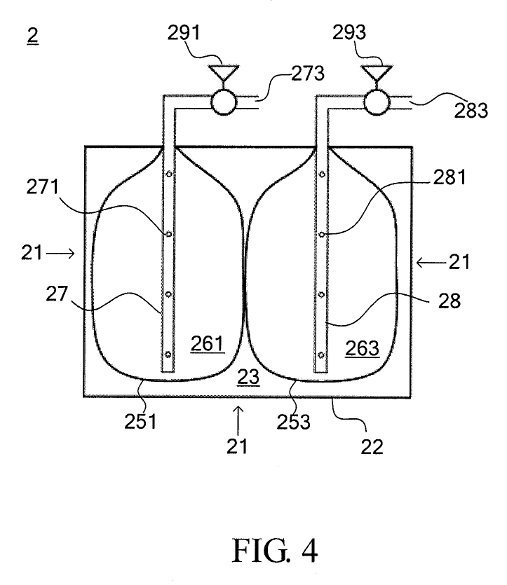

Two or more internal containers also can be used in the fluid delivery device according to the present invention to deliver two or more kinds of fluids to be delivered at the same time to increase the applicability of the device. FIG. 4 shows a fluid delivery device 2 comprising two internal containers according to the present invention. When an external container 22 is heated by a heat source 21, the vapor pressure is generated by heating an assistant liquid in a second space 23 indirectly to compress two internal containers 251 and 253 made of flexible materials to allow the fluid(s) in the first spaces 261 and 263 to flow through the first delivery pipes 27 and 28 via holes 271 and 281 individually, and discharged from the fluid outlets 273 and 283, respectively. The first delivery pipes 27 and 28 are installed with metering valves 291 and 293 to control the flow amount of the fluid(s) to be delivered, respectively.

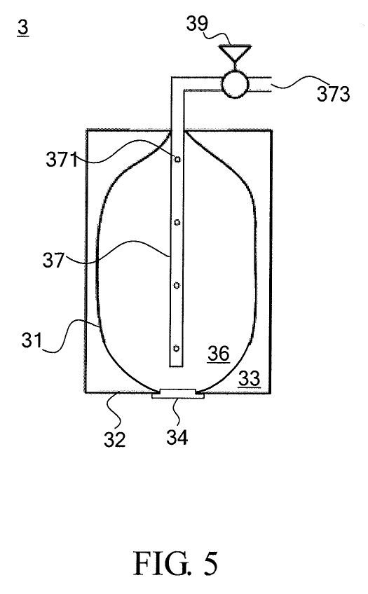

Another embodiment of the present invention is a fluid delivery device 3 as shown in FIG. 5. The fluid delivery device 3 comprises an internal container 31, an external container 32, an assistant liquid in a second space 33, a first delivery pipe 37 with a plurality of holes 371 and a fluid outlet 373, and an optional controlling element 39. The internal container 31 has a first opening from which the first delivery pipe 37 is stretched out as well as a third opening (at the bottom of the internal container 31 as shown in FIG. 5, not indicated). The external container 32 has a second opening from which the first delivery pipe 37 is stretched out and which corresponds to the first opening, and a fourth opening as well (at the bottom of the external container 32 as shown in FIG. 5, not indicated). The third opening and the fourth opening are corresponding and tightly bound to each other to form an inlet to fill/replace the fluid to be delivered in the first space 36.

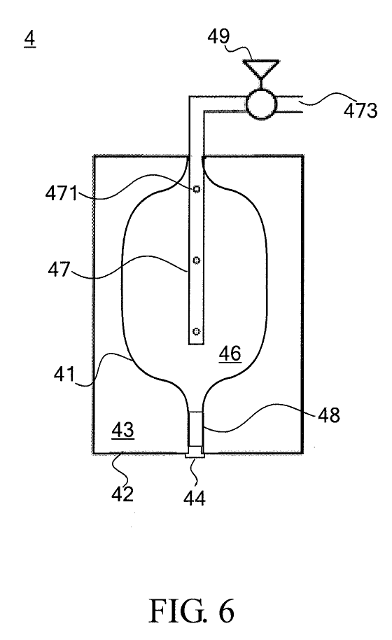

In the aforesaid descriptions, depending on the adopted material, the third opening and the fourth opening can be stuck together by an appropriate chemical or/and physical approach to maintain the substantially sealed state of the second space 33 and prevent the liquid in the internal container 31 from leakage. In addition, the position of the inlet for filling a fluid to be delivered is preferably on the wall of the external container 32 corresponding to the first opening. M ore preferably, as shown in FIG. 5, the inlet is at a position corresponding to the underside of the first opening to alleviate the damage caused by the friction between the internal container 31 and the first delivery pipe 37 (especially the end part) as the internal container 31 is compressed. Moreover, the inlet is installed to correspond to the first switching structure 34, and they may be bound to each other to switch on (as filling) or switch off (as not filling) the inlet depending on the requirements. The first switching structure 34 can be any suitable cover, such as a plug or a screwed cover. The third opening and the fourth opening can be bound to each other through an element, and a binding way thereof is shown in FIG. 6. FIG. 6 shows a fluid delivery device 4 according to the present invention comprising an internal container 41, an external container 42, an assistant liquid in a second space 43, a first delivery pipe 47 with a plurality of holes 471 and a fluid outlet 473, a second delivery pipe 48, and an optional controlling element 49. Also, the internal container 41 additionally has a third opening (not indicated), and the external container 42 additionally has a fourth opening corresponding to the third opening (not indicated). The third opening is tightly bound to the fourth opening through the second delivery pipe 48 to form an inlet (not indicated) installed to correspond to the first switching structure 44 to fill/replace the fluid to be delivered in the first space 46 depending on the requirements. Depending on the adopted material, the second delivery pipe 48 can be tightly bound to the third opening and the fourth opening by using a chemical or/and physical approach to make the second space 43 form a substantially sealed state and prevent the liquid in the internal container 41 from leakage.

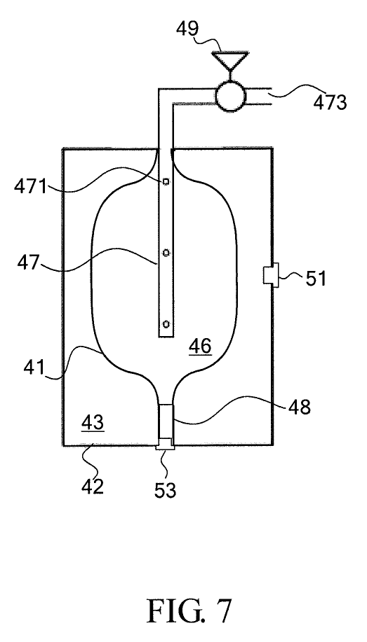

To increase the applicability of the present invention, an inlet for filling an assistant liquid can be additionally installed on the external container of a fluid delivery device optionally to fill the assistant liquid to replace the assistant fluids expediently according to the properties of the fluid to be delivered to enhance the utilization of the fluid delivery device. In this embodiment, the fluid delivery device further comprises a switching structure installed to correspond to the inlet for filling the assistant liquid. As shown in FIG. 7 for example, the fluid delivery device has an inlet and a correspondingly installed third switching structure 53 of which function is substantially the same as the first switching structure 44. There may also optionally be an inlet for filling an assistant liquid (not indicated) and comprise a second switching structure 51 installed to correspond to the inlet.

The present invention will be further illustrated with specific examples as follows to manifest the performance of the present invention.

### EXAMPLE 1

### The Test of the Flow Amount Stability Under the Condition of the Upstanding Position

A fluid delivery device as shown in FIG. 2C was used, wherein the material of an external container 12 was a rigid plastic while that of an internal container 11 was a polyethylene plastic bag. A fluid to be delivered filled in the internal container 11 was water, and an assistant liquid was pentane.

A heat source was provided by means of a water bath, and a needle valve was used as the controlling element of the fluid delivery device. A water manometer was placed in a second space to measure the pressure variation in the second space. First, the fluid delivery device was placed into a water bath at 30° C. After the thermal equilibrium was reached, the needle valve was turned on and fixed to a certain opening. Meanwhile, the relationship of the pressure difference versus the flow amount was measured and recorded, wherein the fluid delivery device is placed in the upstanding position and the recording time started right after the needle valve is turned on. The test result is recorded in Table 1.

TABLE 1

| Time | Temperature | Pressure Difference | Flow Amount |
|---|---|---|---|
| (minute) | (° C.) | (mmH₂O) | (ml/minute) |
| 0 | 30 | 11 | 0.4 |
| 1 | 30 | 11 | 0.4 |
| 2 | 30 | 11 | 0.4 |
| 3 | 30 | 11 | 0.4 |
| 4 | 30 | 11 | 0.4 |
| 5 | 30 | 11 | 0.4 |
| 6 | 30 | 11 | 0.4 |
| 7 | 30 | 11 | 0.4 |
| 8 | 30 | 11 | 0.4 |
| 9 | 30 | 11 | 0.4 |
| 10 | 30 | 11 | 0.4 |
| 11 | 30 | 11 | 0.4 |
| 12 | 30 | 11 | 0.4 |
| 13 | 30 | 11 | 0.4 |
| 14 | 30 | 11 | 0.4 |
| 15 | 30 | 11 | 0.4 |
| 16 | 30 | 11 | 0.4 |
| 17 | 30 | 11 | 0.4 |
| 18 | 30 | 11 | 0.4 |

As can be seen from Table 1, after the pressure in the second space 15 became stable, the flow amount was almost unchanged. Therefore, it is shown that the fluid delivery device according to the present invention can stably provide the function of the fluid delivery without impulse.

### EXAMPLE 2

### The Test of the Flow Amount Stability Under the Condition of Turning the Fluid Delivery Device

Through the same device and heating method as Example 1, the stability of the fluid delivery device was tested, except that the temperature of the water bath was adjusted to 33° C. During the testing process, the fluid delivery device was turned 90° at the 9^{th} minute (i.e. in laid down position), and was turned 90° again at the 12^{th} minute (i.e. being turned 180° from its original position, in upside-down position), and then was turned back to the original upstanding position at the 17^{th} minute. During the process, the relationship of the pressure difference versus the flow amount was measured and recorded. The test result is recorded in Table 2.

TABLE 2

| Time | Temperature | Pressure Difference | Flow Amount |
|---|---|---|---|
| (minute) | (° C.) | (mmH₂O) | (ml/minute) |
| 0 | 33 | 30 | 1.0 |
| 1 | 33 | 29 | 1.0 |
| 2 | 33 | 29 | 1.0 |
| 3 | 33 | 29 | 1.0 |
| 4 | 33 | 29 | 1.0 |
| 5 | 33 | 28 | 1.0 |
| 6 | 33 | 28 | 1.0 |
| 7 | 33 | 28 | 1.0 |
| 8 | 33 | 28 | 1.0 |
| 9 | 33 | 29 | 1.0 |
| (turn 90°) | | | |
| 10 | 33 | 29 | 1.0 |
| 11 | 33 | 29 | 1.0 |
| 12 | 33 | 29 | 1.0 |
| (turn 180°) | | | |
| 13 | 33 | 29 | 1.0 |
| 14 | 33 | 28 | 1.0 |
| 15 | 33 | 28 | 1.0 |
| 16 | 33 | 28 | 0.95 |
| 17 | 33 | 27 | 0.95 |
| (turn 360°) | | | |
| 18 | 33 | 27 | 0.95 |
| 19 | 33 | 28 | 1.0 |
| 20 | 33 | 28 | 1.0 |
| 21 | 33 | 28 | 1.0 |

As shown in Table 2, during the process of turning the fluid delivery device, the flow amount didn't change remarkably. That is, when the fluid delivery device is in a state of use, the placing direction doesn't influence the whole stability or cause obvious variation in the flow amount. Particularly, after the placing direction was altered, the flow amount stabilized immediately. Therefore, it is shown that the fluid delivery device according to the present invention has the non-directional property indeed.

### EXAMPLE 3

### The Test of the Relationship Between the Flow Amount and the Pressure Difference Under the Condition of the Upstanding Position

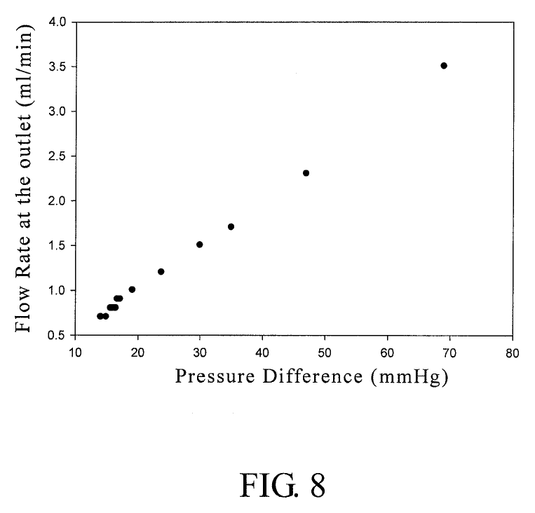

Through the same device and heating method as Example 1, the relationship between the flow amount and the pressure was tested, except that the temperature of the water bath was increased from 30° C. to 40° C. during the testing process to change the pressure in the second space 15. The relationship between the pressure difference and the flow amount was recorded. The test result is recorded in Table 3, and a graph of the pressure difference versus the flow rate at the outlet (i.e. FIG. 8) is made according to the data obtained from Table 3.

TABLE 3

| Pressure Difference | Flow Amount |
|---|---|
| (mmH₂O) | (ml/minute) |
| 15.0 | 0.7 |
| 15.7 | 0.8 |
| 16.1 | 0.8 |
| 16.8 | 0.9 |
| 17.2 | 0.9 |
| 19.2 | 1.0 |
| 16.5 | 0.8 |
| 14.2 | 0.7 |
| 14.1 | 0.7 |
| 15.0 | 0.7 |
| 16.0 | 0.8 |
| 16.0 | 0.8 |
| 23.8 | 1.2 |
| 30.0 | 1.5 |
| 35.0 | 1.7 |
| 47.0 | 2.3 |
| 69.0 | 3.5 |

As can be seen in Table 3 and FIG. 8, the flow amount actually changed with the pressure, and the relationship between both is linearly represented. That is, when the fluid delivery device is in a state of use, the output flow amount can be altered by changing the pressure in the second space 15 without installing the control element of the flow amount additionally.

### EXAMPLE 4

### The Relationship Between the Valve Opening and the Flow Amount

Through the same device and heating method as Example 1, the relationship between the valve opening and the flow amount was tested, except that during the testing process, after the temperature of the device became stable, the needle valve opening (the flow amount at outlet) was set to 1 ml/min, and it was set to 0.4 ml/min during the 11^{th} to the 18^{th} minutes of the testing time, and then it was set to 3.4 ml/min during the 19^{th} to the 30^{th} minutes. The test result is recorded in Table 4.

TABLE 4

| | Flow Amount |
|---|---|
| Time (minute) | (ml/minute) |
| 0.0 | 1.0 |
| 1.0 | 1.0 |
| 2.0 | 1.0 |
| 3.0 | 1.0 |
| 4.0 | 1.0 |
| 5.0 | 1.0 |
| 6.0 | 1.0 |
| 7.0 | 1.0 |
| 8.0 | 1.0 |
| 9.0 | 1.0 |
| 10.0 | 1.0 |
| 11.0 | 0.4 |
| 12.0 | 0.4 |
| 13.0 | 0.4 |
| 14.0 | 0.4 |
| 15.0 | 0.4 |
| 16.0 | 0.4 |
| 17.0 | 0.4 |
| 18.0 | 0.4 |
| 19.0 | 3.1 |
| 20.0 | 3.3 |
| 21.0 | 3.2 |
| 22.0 | 3.2 |
| 23.0 | 3.4 |
| 24.0 | 3.4 |
| 25.0 | 3.4 |
| 26.0 | 3.4 |
| 27.0 | 3.4 |
| 28.0 | 3.4 |
| 29.0 | 3.4 |
| 30.0 | 3.4 |

As can be seen in Table 4, when the valve opening was altered, the flow amount delivered within a unit time can be promptly and stably changed.

From the above examples, it is found that the fluid delivery device according to the present invention has the stable ability of the fluid delivery and meets the demand for changing the delivery flow amount efficiently by altering the intensity of the heat resource or adjusting the switching degree of the control element. In addition, the fluid delivery device according to the present invention is further able to overcome the limit of directivity, and the fluid delivery can be performed in any direction, and thus, it is very suitable for application in portable devices. Moreover, because the fluid delivery device according to the present invention may have a small size, the waste heat, for example, discharged by peripheral devices of an installed system, can be utilized as a heat source, using energy efficiently.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A fluid delivery device, comprising:
an internal container with a first opening and a first space for a fluid to be delivered, wherein the internal container is made of a flexible material;
an external container substantially surrounding the internal container to form a substantially sealed second space between the internal container and the external container, wherein the external container has a second opening corresponding to the first opening and is made of a rigid material;
an assistant liquid in the second space, wherein the boiling point of the assistant liquid is not higher than that of the fluid to be delivered; and
a first delivery pipe, including a first segment within the first space and a second segment stretched out from the first opening, wherein the first segment has a hole for communicating with the first space and the second segment is tightly bound with the first opening and the second opening and has a fluid outlet,
thereby, when the device is in a state of use and the first space contains a fluid to be delivered, the assistant liquid is heated and vaporized by a heat resource to raise the pressure in the second space and to cause a pressure difference between the first space and the second space; and the internal container is compressed by the pressure difference so as to drive the fluid to be delivered to flow out from the delivery device via the first delivery pipe and the fluid outlet.

2. The fluid delivery device as claimed in claim 1, wherein the internal container further comprises a third opening and the external container further comprises a fourth opening corresponding to the third opening; and the device further comprises an optional second delivery pipe, wherein the third opening, the fourth opening and the optional second delivery pipe are tightly bound together to form an inlet for filling the fluid to be delivered into the first space; and the device further comprises a first switching structure for controlling the inlet for filling the fluid to be delivered.

3. The fluid delivery device as claimed in claim 1, further comprising a controlling element installed on the second segment of the first delivery pipe.

4. The fluid delivery device as claimed in claim 3, wherein the controlling element is a metering device.

5. The fluid delivery device as claimed in claim 3, wherein the end of the second segment is capillary-shaped and the controlling element is a switching valve.

6. The fluid delivery device as claimed in claim 1, wherein the heat resource is selected from a group consisting of a high-temperature liquid, a high-temperature gas, chemical reaction heat, an electric heating wire, a heating band, a hot air pipe, a hot liquid pipe, an electric fire, and combinations thereof.

7. The fluid delivery device as claimed in claim 1, wherein the rigid material is selected from a group consisting of a plastic, a metal, and combinations thereof, and the flexible material is selected from a group consisting of polyethylene, polyvinyl chloride (PVC), neoprene, silicone rubber, and combinations thereof.

8. The fluid delivery device as claimed in claim 7, wherein the rigid material is selected from a group consisting of polyethylene, polypropylene, stainless steel, aluminum, and combinations thereof.

9. The fluid delivery device as claimed in claim 1, wherein the material of the first delivery pipe is selected from a group consisting of stainless steel, aluminum, polyvinyl chloride (PVC), polyvinylidene chloride (PVDC), and combinations thereof.

10. The fluid delivery device as claimed in claim 1, wherein the fluid to be delivered is water, methanol, ethanol, or a combination thereof, and the assistant liquid is selected from a group consisting of water, a C₅-C₆ hydrocarbon, a C₂-C₃ carbonyl compound, a C₁-C₂ alcohol, and combinations thereof.

11. The fluid delivery device as claimed in claim 1, wherein the fluid to be delivered is gasoline or diesel fuel and the assistant liquid is selected from a group consisting of gasoline, diesel fuel, methanol, isopropanol, dichloromethane, and combinations thereof.

12. A fluid delivery device, comprising:
an internal container with a first opening and a first space for a fluid to be delivered, wherein the internal container is made of a flexible material;
an external container substantially surrounding the internal container to form a substantially sealed second space between the internal container and the external container, wherein the external container has a second opening and an inlet for filling an assistant liquid and is made of a rigid material; and the second opening corresponds to the first opening;
a second switching structure for controlling the inlet for filling an assistant liquid; and
a first delivery pipe, including a first segment within the first space and a second segment stretched out from the first opening, wherein the first segment has a hole for communicating with the first space and the second segment is tightly bound with the first opening and the second opening and has a fluid outlet,
wherein, when the fluid delivery device is in a state of use, the first space contains a fluid to be delivered and the second space contains an assistant liquid, wherein the boiling point of the assistant liquid is not higher than that of the fluid to be delivered, the assistant liquid is heated and vaporized by a heat resource to raise the pressure in the second space and to cause a pressure difference between the first space and the second space; and the internal container is compressed by the pressure difference so as to drive the fluid to be delivered to flow out from the delivery device via the first delivery pipe and the fluid outlet.

13. The fluid delivery device as claimed in claim 12, wherein the internal container further comprises a third opening and the external container further comprises a fourth opening corresponding to the third opening; and the device further comprises an optional second delivery pipe, wherein the third opening, the fourth opening and the optional second delivery pipe are tightly bound together to form an inlet for filling the fluid to be delivered into the first space; and the device further comprises a third switching structure for controlling the inlet for filling the fluid to be delivered.

14. The fluid delivery device as claimed in claim 12, further comprising a controlling element installed on the second segment of the first delivery pipe.

15. The fluid delivery device as claimed in claim 14, wherein the controlling element is a metering device.

16. The fluid delivery device as claimed in claim 14, wherein the end of the second segment is capillary-shaped and the controlling element is a switching valve.

17. The fluid delivery device as claimed in claim 12, wherein the heat resource is selected from a group consisting of a high-temperature liquid, a high-temperature gas, chemical reaction heat, an electric heating wire, a heating band, a hot air pipe, a hot liquid pipe, an electric fire, and combinations thereof.

18. The fluid delivery device as claimed in claim 12, wherein the rigid material is selected from a group consisting of a plastic, a metal, and combinations thereof; and the flexible material is selected from a group consisting of polyethylene, polyvinyl chloride (PVC), neoprene, silicone rubber, and combinations thereof.

19. The fluid delivery device as claimed in claim 18, wherein the rigid material is selected from a group consisting of polyethylene, polypropylene, stainless steel, aluminum, and combinations thereof.

20. The fluid delivery device as claimed in claim 12, wherein the material of the first delivery pipe is selected from a group consisting of stainless steel, aluminum, polyvinyl chloride (PVC), polyvinylidene chloride (PVDC), and combinations thereof.
